(19) United States
(12) Patent Application Publication
(10) Pub. No.: US 2014/0313388 A1
(43) Pub. Date: Oct. 23, 2014

(54) METHOD FOR PROCESSING INFORMATION AND ELECTRONIC DEVICE

(71) Applicants: Lenovo (Beijing) Co., Ltd., Beijing (CN); Beijing Lenovo Software Ltd., Beijing (CN)

(72) Inventors: Wenfeng Wang, Beijing (CN); Nailei Zhang, Beijing (CN); Jiuru Tang, Beijing (CN); Wenhui Chen, Beijing (CN)

(73) Assignees: Lenovo (Beijing) Co., Ltd., Beijing (CN); Beijing Lenovo Software Ltd., Beijing (CN)

(21) Appl. No.: 14/230,346

(22) Filed: Mar. 31, 2014

(30) Foreign Application Priority Data
Apr. 22, 2013 (CN) 201310139719.9

(51) Int. Cl. H04N 5/232

(52) U.S. Cl. CPC H04N 5/23293; H04N 5/23216
USPC 348/333.05

(57) ABSTRACT

A method for processing information is provided, to reduce the workload of an electronic device. The method includes: determining M images with a first correlation attribute in N images, where M is an integer in a range of 1≦M≦N; displaying by the display unit a first interactive object to enable the M images as a whole to be browsed by the user when the user is browsing the N images, where the first interactive object includes a first image and a first identifier representing one or more of the M images. Another method for processing information and a corresponding electronic device are further provided.

### CROSS REFERENCES OF RELATED APPLICATION

The present application claims the priority to Chinese Patent Application No. 201310139719.9, entitled “METHOD FOR PROCESSING INFORMATION AND ELECTRONIC DEVICE”, filed on Apr. 22, 2013 with the State Intellectual Property Office of People's Republic of China, which is incorporated herein by reference in its entirety.

### FIELD

The present disclosure relates to the technical field of computer and embedded system, and in particular to a method for processing information and an electronic device.

### BACKGROUND

With the development of science and technology, the electronic technology is also developing rapidly. Electronic devices are becoming more varied, and accordingly people could share the convenience brought by the development of science and technology. At present, people can enjoy their life with the development of science and technology via a various types of electronic devices. For instance, the electronic device such as cellphone, by which people can phone or send short messages to contact other people, has been an indispensable part of daily life.

Conventionally, the camera modules of both cellphone and camera have a continuous shoot function to help a user to capture the entire dynamic process. Conventionally, while browsing the images in continuous shoot, the continuous shot images are displayed one by one for people's browse, i.e., the method for displaying continuous shot images is as the same as that of ordinary images, that is to say, the pictures are displayed in sequence. Hence, a user needs to browse the pictures in sequence, which may cause a waste of time. In addition, the continuous shot pictures may be similar to each other, and the user may imagine the shot content and effect after browsing only one or two of the pictures. In this case, the user may be ready to browse those pictures posterior to the continuous shoot. According to the display mode in the conventional technology, the user needs to browse completely the continuous shot images before browsing the subsequent non-continuous shot pictures, which may result in a waste of time, a power consumption because of the electronic device's responding to user's multiple operations, and an increased mis-response rate due to multiple continuous responses. In addition, according to the display method in the conventional technology, a user may determine by himself (herself) whether a certain picture is a continuous shot one rather than be reminded by the electronic device, hence the intellectualization of the electronic device is low.

### SUMMARY

It is to provide a method for processing information and an electronic device to solve the problem in the existing technology such as an increased incorrect response rate resulted in multiple times of response of the electronic device, thereby decreasing the incorrect response rate of the electronic device.

A method for processing information applicable in an electronic device including a display unit, where a user browses N images via the display unit of the electronic device, where N is an integer greater than or equal to 1, where the method includes:

determining M images with a first correlation attribute from the N images, wherein M is integer in a range of 1≦M≦N;

displaying by the display unit a first interactive object to enable the M images as a whole to be browsed by the user in a case that the user browses the N images;

wherein the first interactive object comprises a first image and a first identifier representing one or more of the M images.

Preferably, the M images with the first correlation attribute are captured via a continuous shoot function of the electronic device within a first period of time.

Preferably, the first correlation attribute is obtained by determining a similarity among the M images to be greater than a threshold in an image analysis algorithm.

Preferably, the M images with the first correlation attribute are stored in one folder.

Preferably, the first identifier is an icon representing that the first interactive object includes a plurality of files.

Preferably, the first image is one of the M images.

Preferably, the first image includes thumbnails of I images of the M images, where I is an integer in a range of 1≦I≦M.

Preferably, the method further includes:

detecting whether a first operation performed on the first interactive object is received;

presenting the M images on the display unit in a first mode in a case that the first operation performed on the first interactive object is received.

Preferably, the first mode is to skip to a first folder where the M images are stored.

Preferably, the first mode is further to display thumbnails of the M images on the display unit.

Preferably, the first mode is further to display the M images in sequence via slide.

A electronic device, including a display unit, where the user browses N images via the display unit of the electronic device, where N is an integer greater than or equal to 1, where the electronic device includes:

a determining module, configured to determine M images with a first correlation attribute from the N images, wherein M is an integer in a range of 1≦M≦N;

the display unit, configured to display a first interactive object such that the M images as a whole are browsed by the user in a case that the user browses the N images, wherein the first interactive object comprises a first image and a first identifier representing one or more of the M images.

Preferably, the M images with the first correlation attribute are captured via a continuous shoot function of the electronic device within a first period of time.

Preferably, the first correlation attribute is obtained by determining a similarity among the M images to be greater than a threshold in an image analysis algorithm.

Preferably, the M images with the first correlation attribute are stored in one folder.

Preferably, the first identifier is an icon representing that the first interactive object includes a plurality of files.

Preferably, the first image is one of the M images.

Preferably, the first image comprises thumbnails of I images of the M images, wherein I is an integer in a range of 1≦I≦M.

Preferably, the electronic device further includes a detecting module configured to detect whether a first operation performed on the first interactive object is received,

where the display unit is further configured to present the M images in a first mode in a case that the first operation performed on the first interactive object is received.

Preferably, the first mode is to skip to a first folder where the M images are stored.

Preferably, the first mode is further to display thumbnails of the M images on the display unit.

Preferably, the first mode is further to display the M images in sequence via slide.

The method for processing information provided according to the embodiments of the disclosure may be applied to an electronic device provided with a display unit, and a user may browse N images via the display unit of the electronic device, where N is an integer greater than or equal to 1. The method may include: determining M images of a first correlation attribute in the N images, where M is an integer greater than or equal to 1 and smaller than or equal to M; displaying by the display unit a first interactive object to make the M images to be browsed by the user as a whole when the user is browsing the N images, where the first interactive object includes a first image and a first identifier which may represent one or more of the M images.

In an embodiment, the M images of the first correlation attribute may be determined from the N images. If the display unit is required to display the M images, the first interactive object may be displayed on the display unit to enable the M images as a whole to be browsed by the user, i.e., the M images may be presented to the user as a whole, hence the operation on the M images may be realized by a single direct operation on the first interactive object. For example, in a case that the user intends to browse the images captured in the continuous shoot process, there is no need to browse the images in sequence, the electronic device may display directly the first interactive object for the user, where the first interactive object may be equivalent to an image displayed on the display unit. After viewing only one image, the user may understand that this image represents a series of images captured in the continuous shoot process. For the electronic device, in a case that the user intends to browse the images captured in continuous shoot process, the electronic device may respond only once before showing the pictures captured in continuous shoot process to the user, and then the workload of the electronic device is less, and there may be no need for the user to browse the images in sequence, thereby reducing the time cost and improving the operating efficiency.

### BRIEF DESCRIPTION OF THE DRAWINGS

FIG. 1 is a flow chart of a method for processing information according to an embodiment of the invention;

FIG. 2A is a schematic diagram of a first interactive object according to the embodiment of the invention;

FIG. 2B is another schematic diagram of a first interactive object according to the embodiment of the invention;

FIG. 2C is a schematic diagram showing that M images are displayed on a display unit display according to the embodiment of the invention; and

FIG. 3 is a detailed structure diagram of an electronic device according to the embodiment of the invention.

### DETAILED DESCRIPTION

The method for processing information according to the embodiment of the invention may be applied to an electronic device provided with a display unit, and a user may browse N images via the display unit of the electronic device, where N is an integer greater than or equal to 1. The method may include: determining M images with a first correlation attribute in N images, where M is an integer in a range of 1≦M≦N; displaying by the display unit a first interactive object to enable the M images as a whole to be browsed by the user when a user is browsing the N images, where the first interactive object includes a first image which may represent one or more of the M images and a first identifier.

In an embodiment, the M images with the first correlation attribute may be determined from the N images. If the M images is required to display, the first interactive object may be displayed on the display unit to enable the M images as a whole to be browsed by the user, i.e., the M images may be presented to the user as a whole, hence an operation on the M images may be realized by a single direct operation on the first interactive object. For example, in a case that the user intends to browse the continuous shot images, there is no need to browse the images in sequence as the conventional technology, the electronic device may display directly the first interactive object for the user, where the first interactive object may be equivalent to one image displayed on the display unit. The user may review this one image to learn the series of continuous shot images. In a case that the user intends to browse the continuous shot images, the electronic device may respond only once for showing the continuous shot images to the user, which may lead to a decreased workload, a reduced time due to avoidance of browsing the images in sequence, and an improved operating efficiency.

In an embodiment, the electronic device may be a cellphone, a camera, a PAD or other electronic devices with image capture function. The types of the electronic device may not be limited in this disclosure.

In an embodiment, the electronic device may include an image capture unit, or, the electronic device does not include an image capture unit, but communicates with an image capture unit.

In an embodiment, the image capture unit may be a camera or a function module with image capture function, which is not limited in the disclosure.

In an embodiment, the image capture unit may include the continuous shoot mode and a non-continuous shoot mode. For example, the image capture unit may include the continuous shoot mode, and besides, an ordinary camera mode and a video capture mode, etc.

The technical solution may be described in the following in conjunction with embodiments and drawings.

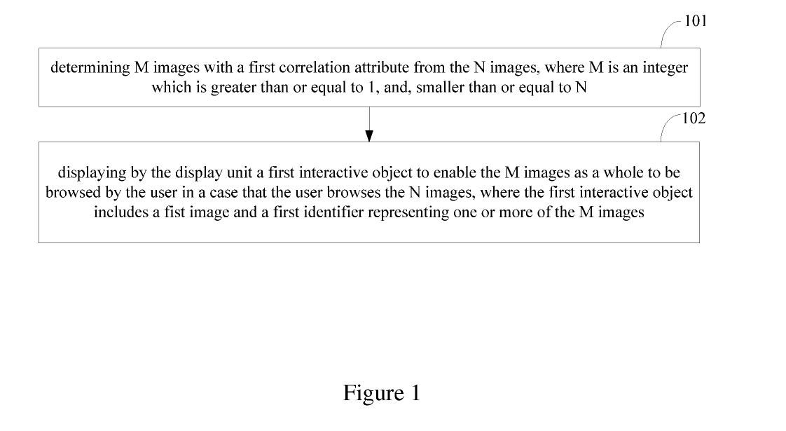

FIG. 1 is a flow chart of a method for processing information according to the embodiment of the invention. The method may be applied to an electronic device with an image capture unit. The image capture unit may have a continuous shoot function, and the electronic device may further include a display unit. The method includes the step as follows.

In step 101, M images with a first correlation attribute are determined from N images, where M is an integer in a range of 1≦M≦N.

In an embodiment, the electronic device may capture the N images via the image capture unit.

In an embodiment, the first correlation attribute may refer to different correlation properties among pictures.

Optionally, the M images with the first correlation attribute may be captured via a continuous shoot function of the electronic device within a first period of time.

In an embodiment, since the electronic device may include the image capture unit or the electronic device may communicate with the image capture unit, the continuous shoot function of the image capture unit is equivalent to the continuous shoot function of the electronic device.

Optionally, the first correlation attribute may be obtained by determining a similarity among the M images to be greater than a threshold in an image analysis algorithm.

For example, the image capture unit captures the M images not using the continuous shoot function, however, the similarity among the M images is greater than the threshold, hence it may be determined that the M images are of the first correlation attribute.

Optionally, the M images with the first correlation attribute may be stored in one folder.

For example, the electronic device may function as storing automatically certain images into a folder, hence the electronic device may store the N images into different folders. Hence, the images in the same folder may be considered to have the first correlation attribute.

For example, if the user intends to capture multiple continuous shot images in a case of continuous shoot mode of the image capture unit, the user may operate the electronic device to perform continuous shoot. For example, the photographing operation may include the process of: pressing or clicking a button for camera of the electronic device by the user; and obtaining a series of continuous shot images by the electronic device in response to the camera operation.

In an embodiment, the M images may be captured via the continuous shoot function of the electronic device for once or more within a first period of time, i.e., all of the M images may be captured in one shoot process, or different images of the M images may be captured in different shoot processes.

In an embodiment, in a case that the M images are captured in a continuous shoot process and the M images are stored in one folder, the electronic device needs to establish the folder. For example, the folder may be named a first folder. The process of establishing the first folder by the electronic device may include:

In an embodiment, since all of the M images may be captured in one shoot process or different images of the M images may be captured in different shoot processes, the M images may be determined from the N images, where the M images are captured by the image capture unit in one continuous shoot process.

According to embodiments of the invention, the method for determining the M images from the N images may be varied.

For example, the method for determining the M images from the N images may include: determining the M images from the N images according to a first identifier corresponding to the shoot process.

For example, the N images correspond to four times of continuous shoot, and it is determined from the N images that the M images are captured in a first one of the four continuous shoot processes.

In an embodiment, the serial number of each shoot process may correspond to an identifier. For example, a first shoot process corresponds to a first identifier, and a second shoot process corresponds to a second identifier. In a case that the image capture unit captures multiple images in one continuous shoot process, the electronic device may establish a corresponding relation between the serial number of the one continuous shoot process and an identifier.

For example, the N images correspond to four shoot processes. The electronic device may establish a corresponding relation between the first shoot process and a first identifier after the first shoot process is completed. The electronic device may establish a corresponding relation between a second shoot process and a second identifier after the second shoot process is completed. The electronic device may establish a corresponding relation between a third shoot process and a third identifier after the third shoot process is completed. The electronic device may establish a corresponding relation between a fourth shoot process and a fourth identifier after the fourth shoot process is completed.

After the electronic device establishes a corresponding relation between the serial numbers of the shoot processes and the identifiers, a certain image may include a corresponding identifier. In this case, the serial number of shoot process for any image may be learned according to the identifier contained in the image.

For example, the electronic device may establish a corresponding relation between the first shoot process and the first identifier after the first shoot process is completed. For example, the M images are captured in the first shoot process, the electronic device may enable each of the M images to include the first identifier after the corresponding relation is established.

For example, the electronic device may establish a corresponding relation between the second shoot process and the second identifier after the second shoot process is completed. For example, the P images are captured in the second shoot process, the electronic device may enable each image of the P images to include the second identifier after the corresponding relation is established, until each of the N images includes the corresponding identifier.

In an embodiment, after the electronic device enables each of the N images to include the corresponding identifier, the electronic device may generate the first folder for the M images of the N images, where the first folder may include the M images.

After the electronic device enables each of the N images to include the corresponding identifier, for example, in order to generate the first folder corresponding to the first shoot process, the electronic device may determine the M images including the first identifier from the N images according to the identifiers of images, and generate the first folder according to the N images.

For example, for an ith image of the N images, the electronic device may determine whether the ith image includes the first identifier, where i is an integer from 1 to N. In a case that the electronic device determines that the ith image includes the first identifier, it may be determined that the ith image is one of the M images; otherwise, in a case that the ith image does not include the first identifier, it may be determined that the ith image is not one of the M images.

Alternatively, in an embodiment, the electronic device may generate the first folder for multiple images in each continuous shoot process. For example, the electronic device may establish a corresponding relation between the first shoot process and the first identifier after the first shoot process is completed. For example, the M images is captured in the first shoot process, the electronic device may enable each of the M images to include the first identifier after the corresponding relation is established, and generate the first folder for the M images. In this case, M may be equal to N.

Alternatively, the electronic device may generate the first folder for multiple images in each continuous shoot process, and may not establish a corresponding relation between the serial number of shoot process and the identifier, i.e., there is no need to enable each image to include an identifier. After photographing multiple images in one time of continuous photographing, the electronic device may generate the folder corresponding to the images, and the images may be included in the corresponding folder; this may simplify the operation, improves the operational efficiency, and reduces the error rate.

In step 102, a first interactive object is displayed on the display unit in a way that the M images as a whole are browsed by a user in a case that the user browses the N images.

In an embodiment, the user may browse the N images via the display unit. In a case that the user browses a certain one of the N images, i.e., the display unit is required to display a certain one of the N images, the display unit may display directly the first interactive object. The first interactive object may be the all and the one, such as an image or an icon, this may lead to the M images' browse to the user as a whole.

In Step 103, the first interactive object includes a first image and a first identifier representing one or more of the M images.

In an embodiment, the first interactive object may include the first image and the first identifier representing one or more of the M images.

In an embodiment, the first identifier is to represent that the first interactive object includes multiple files. For example, the first identifier may be an icon or others.

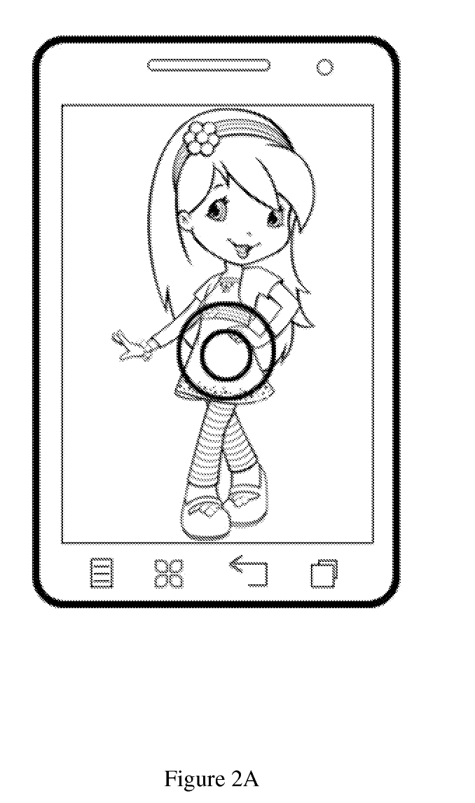

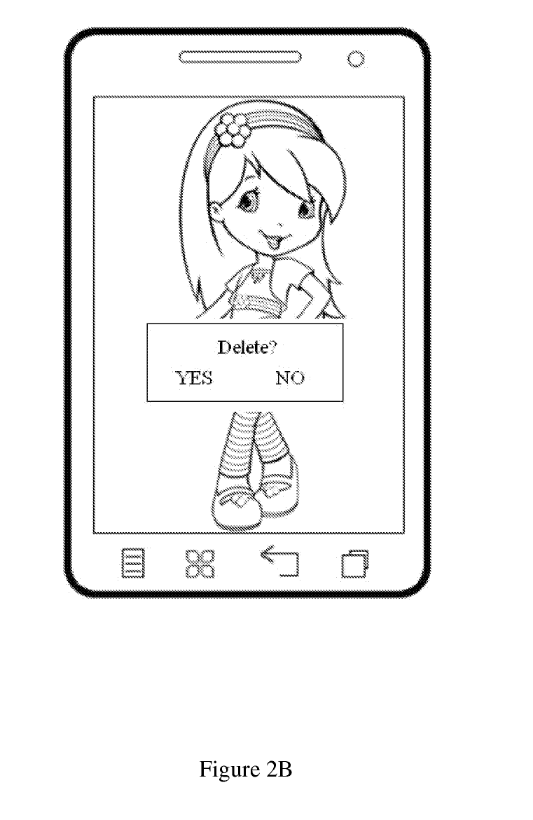

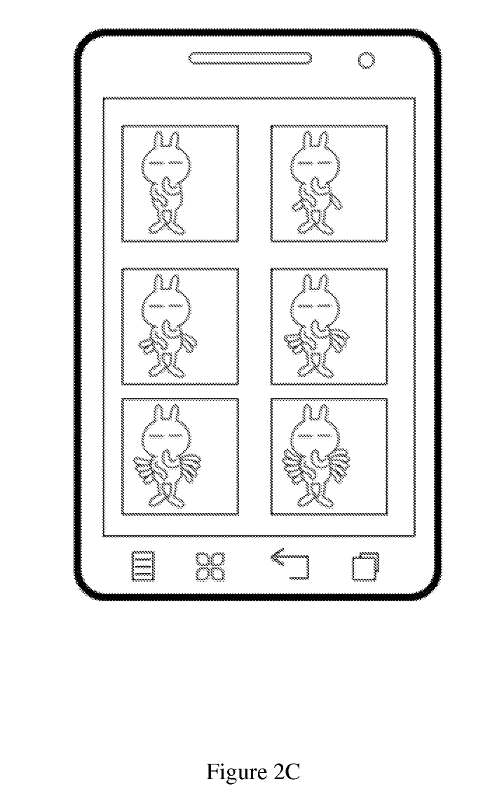

Optionally, in an embodiment, the first image may be one of the M images, i.e., the electronic device may select one from the M images as the first image. As shown in FIG. 2A, the circles in FIG. 2A represent the first identifier.

The electronic device may select any one from the M images as the first image.

In a case that the M images are captured in a continuous shoot process, the images differ from each other a little, and the user needs to browse only one of the M images to get a general browse of the multiple images captured in the continuous shoot process. Hence, in a case that the M images captured in the continuous shoot process are required to be displayed, only one of the M images is displayed on the display unit, such that the user may not be disturbed in browsing the images and the respond time of the electronic device may be reduced.

Alternatively, the electronic device may select a specified one from the M images as the first image.

In a case that the electronic device may select a specified one from the M images as the first image, a possible embodiment is to select specified one from the M images as the first image based on a selection of the user.

Optionally, in an embodiment, the first image may include thumbnails of I images of the M images, where I is an integer in a range of 1≦I≦M.

For example, the thumbnails of I images of the M images may be jointed, and the jointed image may be taken as the first image.

For example, M=8. In this case, the I images may be selected arbitrarily or based on an operation from the user from the M images for joint.

Preferably, the thumbnails of the M images may be jointed such that the M images are equivalent to be processed as one image. In a case that the user catches sight of the first interactive object, the user may browse all the images captured in the continuous shoot by browsing only one image, and then the user may determine at once whether to browse each image captured in the continuous shoot or whether to delete a part of the images, etc.

Alternatively, only a part of the M images may be selected to be jointed, and then each original of the jointed image may be clear, which may be convenient for the user.

In an embodiment, in a case that the M images captured in one shoot process are required to be displayed, only the first interactive object corresponding to the M images may be displayed on the display unit, and that is equivalent to display only one image on the display unit, and then the electronic device is required to respond only once, hence the workload of the electronic device is light. The user does not need to perform multiple operations, which reduces the operation time and improves the operational efficiency.

In an embodiment, the first image corresponds to the first identifier, and the first image and the first identifier may be two independent components. For example, the first identifier may be suspended on the first image. For example, the first identifier may be a small icon or others. The user may browse the M images by operating on the first identifier.

For example, the M images are stored in the first folder, the user may enter into the first folder by clicking the first identifier and browse the M images in the first folder.

Furthermore, in an embodiment, the first identifier and the first image are displayed on the display unit, the user may think that there is no need to browse the M images. For example, the user may intend to browse other images forwards or backwards, or to delete the M images corresponding to the first interactive object. As shown in FIG. 2, the user may perform a second operation on the first interactive object. The electronic device may respond to the second operation and process the M images in a second operation mode corresponding to the second operation.

For example, the second operation performed by the user is to move the first interactive object, the electronic device may respond to the second operation such that the display unit may display those of the N images excepting the M images. For example, the second operation performed by the user is to delete the first interactive object, the electronic device may respond to the second operation and delete the M images corresponding to the first interactive object.

In this way, the user may operate directly on the first interactive object, which is equivalent to operate on the M images, i.e., the user may operate on the M images by operating only once, Hence, the electronic device may get a reduced number of responding times, a lightened workload. The user may get a reduced number of operating times and a shortened operating time.

Furthermore, in an embodiment, after Step 103, the electronic device may further detect itself periodically, in a real time manner or via suffering from trigger, to determine whether the first operation performed on the first interactive object is received.

In a case that it is determined that the first operation is received, the M images may be displayed on the display unit in a first mode.

Optionally, in an embodiment, in a case that the M images are stored in the first folder, the first mode refers to skip to the first folder where the M images are stored such that the M images may be displayed on the display unit. FIG. 2C is taken for an example in which the M images are captured in a continuous shoot process.

Optionally, in an embodiment, the first mode may refer to display the thumbnails of the M images on the display unit.

Since M may be a large number or the space occupied by each image may be large, the display unit can not display all the M images once, however, the thumbnails of the M images may be displayed on the display unit. Hence, the user may browse all the M images once.

Optionally, in an embodiment, the first mode may refer to display each of the M images in sequence via slide.

For example, the user may intend to browse the M images after the first image and the first identifier are displayed on the display unit. In this case, the user may perform the first operation on the first interactive object. For example, the user may click the first identifier. In a case that the first operation is performed by the user, the electronic device may detect the first operation and respond to the first operation, and display the M images on the display unit in the first mode.

For example, in a possible scenario that it is required to display the M images captured in the continuous shoot process and the first interactive object is displayed on the display unit, the user after catching sight of the first interactive object intends to browse the M images captured in the continuous shoot process, and then the user may click the first identifier of the first interactive object, i.e., the user may perform the first operation. the electronic device may respond to the first operation after receiving the first operation, and display the M images on the display unit.

In an embodiment, the M images are displayed on the display unit, and the size of the display unit is limited, the user may review less than M images once and need to browse the other images which may not be displayed once by operations such as sliding if M is a large number, i.e., the first folder includes plenty of images.

Furthermore, the user may intend to operate on one or more of the M images; for example, the user intends to edit an image or delete one or more images, and then the user may perform a third operation on the second one of the M images. For example, the third operation may be editing, copying or deleting, etc. The electronic device may respond to the third operation after receiving the third operation and process accordingly the second image in a third operation mode corresponding to the third operation.

For example, in a case that the third operation performed by the user is to copy the second image, the electronic device may respond to the third operation and copy the second image after receiving the third operation. In a case that the third operation performed by the user is to delete the second image, the electronic device may respond to the third operation and delete the second image after receiving the third operation.

In this way, in a case that the user intends to operate on a certain one or certain ones of the M images, the user may perform the operation after the M images are displayed on the display unit.

With the solutions according to the embodiments of the invention, the user's operation on each image may not be influenced, the workload of the electronic device may be lightened, and the number of operating time may be reduced.

The method for processing information may be described in the following in conjunction with embodiments, where the following embodiments mainly describe certain possible application scenarios of the method. It should be noted that, the embodiments are only to help better understanding of the disclosure but not to limit the disclosure.

### Embodiment 1

The electronic device is a cellphone. The image capture unit is a camera of the cellphone. The image capture unit has a continuous shoot function. The display unit is a display screen of the cellphone.

In an embodiment, the electronic device may display captured N images on the display unit after receiving a corresponding operation from a user. For example, the user may click a corresponding button, which is configured to review images and displayed on the display unit of the electronic device, and then the electronic device may respond to the user's operation and display the captured images on the display unit. The images may be captured in both continuous and non-continuous shoots.

In an embodiment, M images of the N images have a first correlation attribute. The first correlation attribute refers to a property that the M images are captured via the continuous shoot function of the electronic device within a first period of time.

In a case that the electronic device is required to display the M images on the display unit, the electronic device may determine that the M images have the first correlation attribute, and then the electronic device may determine a first interactive object corresponding to the M images.

In an embodiment, the first interactive object may include a first image and a first identifier corresponding to the M images. In an embodiment, the first image may be any one of the M images. After the first interactive objective is determined, the first interactive object may be displayed on the display unit. In this case, the first interactive object may represent the M images.

In an embodiment, the first identifier corresponds to the first image, however, the first image and the first identifier may be two independent components. For example, the first identifier may be suspended on the first image. For example, the first identifier may be a small icon or others. The user may browse the M images by operating on the first identifier. For example, the user may enter into the first folder by clicking a first identifier, and then the M images included in the first folder may be browsed.

In an embodiment, after the first image and the first identifier are displayed on the display unit, the user may think that there is no need to browse other images in the first folder. For example, the user may intend to browse other images forward or backward, and the user may perform the second operation on a first folder identifier

After receiving the second operation, the electronic device may respond to the second operation, and process the first folder in the second operation mode corresponding to the second operation.

In an embodiment, the display unit is a touch-display unit, and the second operation performed by the user is to slide on the touch-display unit, and then the electronic device may respond to the second operation after receiving the second operation and move the first interactive object on the display unit. A resultant may be that the display unit may display other images rather than the first interactive object.

### Embodiment 2

The electronic device is a PAD. The image capture unit is a camera of the PAD. The image capture unit has a continuous shoot function. The display unit is a display screen of the PAD.

In an embodiment, the electronic device may display captured N images on the display unit after receiving a corresponding operation from a user. For example, the user may click a corresponding button, which is configured to review images and displayed on the display unit of the electronic device, and then the electronic device may respond to the user's operation and display the captured images on the display unit. The images may be captured in both continuous and non-continuous shoots.

In an embodiment, M images of the N images have a first correlation attribute. The first correlation attribute refers to a property that the M images are captured via the continuous shoot function of the electronic device within a first period of time.

In a case that the electronic device is required to display the M images on the display unit, the electronic device may determine that the M images have the first correlation attribute, and then the electronic device may firstly determine a first interactive object corresponding to the M images.

In an embodiment, the first interactive object may include a first image and a first identifier corresponding to the M images. In an embodiment, the first image may be thumbnails of I images of the M images. After the first interactive objective is determined, the first interactive object may be displayed on the display unit. In this case, the first interactive object may represent the M images.

In an embodiment, the first identifier corresponds to the first image, however, the first image and the first identifier may be two independent components. For example, the first identifier may be suspended on the first image. For example, the first identifier may be a small icon or others. The user may browse the M images by operating on the first identifier.

In an embodiment, after the first image and the first identifier are displayed on the display unit, the user may intend to browse the M images. In this case, the user may operate a first operation on the first identifier. For example, the user may click on the first identifier. After the user performs the first operation, the electronic device may receive the first operation and display the M images in response to the first operation.

### Embodiment 3

The electronic device is a camera. The image capture unit is a lens of the camera. The image capture unit has a continuous shoot function. The display unit is a display screen of the camera.

In an embodiment, the electronic device may display captured N images on the display unit after receiving a corresponding operation from a user. For example, the user may click a corresponding button, which is configured to review images and displayed on the display unit of the electronic device, and then the electronic device may respond to the user's operation and display the captured images on the display unit. The images may be captured in both continuous and non-continuous shoots.

In an embodiment, M images of the N images have a first correlation attribute. The first correlation attribute refers to a property that the M images are captured via the continuous shoot function of the electronic device within a first period of time. The M images are stored in one folder, where the folder is a first folder.

In a case that the electronic device is required to display the M images on the display unit, the electronic device may determine that the M images have the first correlation attribute, and then the electronic device may firstly determine a first interactive object corresponding to the M images.

In an embodiment, the first interactive object may include a first image and a first identifier corresponding to the M images. In an embodiment, the first image may be any one of the M images. After the first interactive objective is determined, the first interactive object may be displayed on the display unit. In this case, the first interactive object may represent the M images.

In an embodiment, the first identifier corresponds to the first image, however, the first image and the first identifier may be two independent components. For example, the first identifier may be suspended on the first image. For example, the first identifier may be a small icon or others. The user may enter into the first folder by operating on the first identifier. For example, the user may enter into the first folder by clicking a first identifier, and then the M images included in the first folder may be browsed.

In an embodiment, after the first image and the first identifier are displayed on the display unit, the user may intend to browse the images in the first folder, i.e., to browse the M images. In this case, the user may perform a first operation on the first identifier. For example, the user may click on the first identifier. After the user performs the first operation, the electronic device may receive the first operation, and the electronic device may respond to the first operation and display the images in the first folder, i.e., display the M images on the display unit. In an embodiment, the electronic device may display the thumbnails of the M images on the display unit.

In an embodiment, after the M images are displayed on the display unit, the user may intend to operate on one or more images therein. For example, the user intends to delete a second one of the M images, the user may perform a third operation on the second one of the M images. The electronic device may respond to the third operation after receiving the third operation, and process accordingly the second image in a third operation mode corresponding to the third operation.

In an embodiment, the third operation performed by the user is to delete the second image, and then the electronic device may respond to the third operation after receiving the third operation to delete the second image included in the first folder.

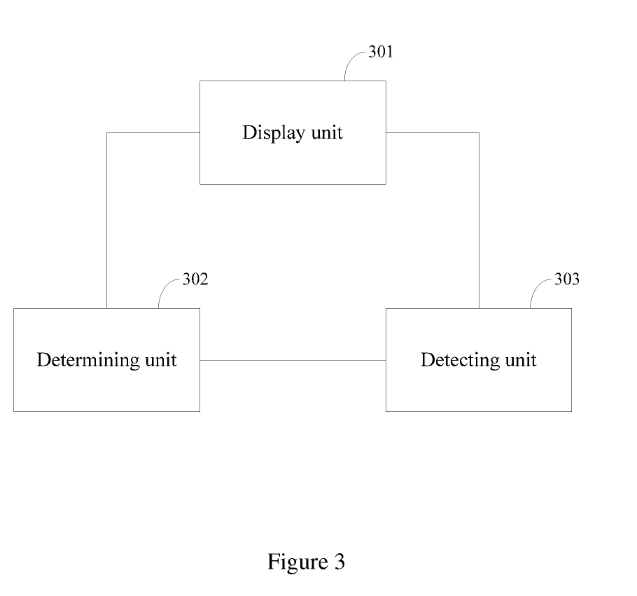

As shown in FIG. 3, an electronic device is provided according to the embodiment of the invention. The electronic device may include a display unit 301, by which the user may browse N images, where N is an integer greater than or equal to 1. The electronic device may further include a determining module 302.

Preferably, the electronic device may further include a detecting module 303.

The determining module 302 may be configured to determine M images with a first correlation attribute in N images, where M is an integer in a range of 1≦M≦N.

The display unit 301 is configured to display a first interactive object such that the M images as a whole are browsed by the user in a case that the user browses the N images, where the first interactive object includes a first image and a first identifier representing one or more of the M images.

The display unit 301 is further configured to display the M images in a first mode on receiving a first operation on the first interactive object.

In an embodiment, the M images with the first correlation attribute may be captured via a continuous shoot function of the electronic device within a first period of time.

In an embodiment, the first correlation attribute may be obtained by determining a similarity among the M images to be greater than a threshold in an image analysis algorithm.

In an embodiment, the M images with the first correlation attribute may be stored in one folder.

In an embodiment, the first identifier is an icon representing that the first interactive object includes multiple files.

In an embodiment, the first image is one of the M images.

In an embodiment, the first image includes thumbnails of I images of the M images, where I is an integer in a range of 1≦I≦M.

The detecting module 303 is configured to determine whether the first operation performed on the first interactive object is received.

In an embodiment, the first mode is to skip to a first folder where the M images are stored.

In an embodiment, the first mode is to display the thumbnails of the M images on the display unit.

In an embodiment, the first mode is to display in sequence each of the M images via slide.

The method for processing information according to the embodiments of the invention may be applied to an electronic device provided with a display unit, and a user may browse N images via the display unit of the electronic device, where N is an integer greater than or equal to 1. The method may include: determining M images with a first correlation attribute in the N images, where M is an integer in a range of 1≦M≦N; displaying by the display unit a first interactive object to enable the M images as a whole to be browsed by the user when the user is browsing the N images, where the first interactive object includes a first image and a first identifier representing one or more of the M images.

In an embodiment, the M images with the first correlation attribute may be determined from the N images. If the display unit is required to display the M images, the first interactive object may be displayed on the display unit to enable the M images as a whole to be browsed by the user, i.e., the M images may be presented to the user as a whole, hence the operation on the M images may be realized by a single direct operation on the first interactive object. For example, in a case that the user intends to browse the images captured in a continuous shoot process, there is no needed to browse the images in sequence, the electronic device may display directly the first interactive object for the user, where the first interactive object may be equivalent to an image displayed on the display unit. After viewing only one image, the user may understand that this image represents a series of images captured in the continuous shoot process. For the electronic device, in a case that the user intends to browse the images captured in continuous shoot process, the electronic device may respond only once before showing the pictures captured in the continuous shoot process to the user, and then the workload of the electronic device is less, and there may be no need for the user to browse the images in sequence, thereby reducing the time cost and improving the operating efficiency.

Those skilled in the art may understand that the embodiments of the invention may provide a method, a system or a computer program. Therefore, this disclosure may be implemented only by hardware or software, or by both hardware and software. In addition, this disclosure may be applied in one or more computer program products performed on the computer-usable storage medium (including but limited to disk storage and optical storage) including computer-usable program code.

The disclosure is described according to the method, the device (system) and the flow chart and/or the block diagram of the computer program product. It should be understood that the computer program instructions may implement each procedure and/or the block in the flow chart and/or the block diagram, and the combination of the procedure and/or the block in the flow chart and/or the block diagram. These computer program instructions may be applied in general computer, specialized computer, embedded computer, or processor of other programmable date processing device to produce a machine, by which a device configured to realize the functions specified in one or more blocks in the block diagram and/or one or more procedures in the flow chart may be produced via the instructions performed by computer or processor of other programmable date processing device

These computer program instructions may be further stored in a computer-readable storage medium capable of leading the computer or other programmable date processing device to work in a specific way such that the instructions stored in the computer-readable storage may generate a product including an instruction apparatus, where the instruction apparatus may realize the function specified in one or more blocks in the block diagram and/or one or more procedures in the flow chart.

These computer program instructions may be further loaded on computer or other programmable date processing device such that the computer or other programmable device may perform a series of operating procedures to generate a processing realized by computer, hence the instruction performed on the computer or other programmable device may provide the procedures for realizing the function specified in one or more blocks in the block diagram and/or one or more procedures in the flow chart.

Obviously, those skilled in the art may make various modifications and improvements within the principle and scope of the disclosure; hence the disclosure means to include these modifications and improvements in a case that these modifications and improvements are within the protection scope of the claims.

1. A method for processing information applicable in an electronic device comprising a display unit, wherein a user can browse N images via the display unit of the electronic device, wherein N is an integer greater than or equal to 1, wherein the method comprises:
determining M images with a first correlation attribute from the N images, wherein M is integer in a range of 1≦M≦N;
displaying by the display unit a first interactive object to enable the M images as a whole to be browsed by the user in a case that the user browses the N images;
wherein the first interactive object comprises a first image and a first identifier representing one or more of the M images.

2. The method according to claim 1, wherein the M images with the first correlation attribute are captured via a continuous shoot function of the electronic device within a first period of time.

3. The method according to claim 1, wherein the first correlation attribute is obtained by determining a similarity among the M images to be greater than a threshold in an image analysis algorithm.

4. The method according to claim 1, wherein the M images with the first correlation attribute are stored in one folder.

5. The method according to claim 1, wherein the first identifier is an icon representing that the first interactive object includes a plurality of files.

6. The method according to claim 1, wherein the first image is one of the M images.

7. The method according to claim 1, wherein the first image comprises thumbnails of I images of the M images, wherein I is an integer in a range of 1≦I≦M.

8. The method according to claim 1, further comprising:
detecting whether a first operation performed on the first interactive object is received; and
presenting the M images on the display unit in a first mode in a case that the first operation performed on the first interactive object is received.

9. The method according to claim 8, wherein the first mode is to skip to a first folder where the M images are stored.

10. The method according to claim 8, wherein the first mode is further to display thumbnails of the M images on the display unit.

11. The method according to claim 8, wherein the first mode is further to display the M images in sequence via slide.

12. A electronic device, comprising a display unit, wherein the user browses N images via the display unit of the electronic device, wherein N is an integer greater than or equal to 1, wherein the electronic device comprises:
a determining module, configured to determine M images with a first correlation attribute from the N images, wherein M is an integer in a range of 1≦M≦N;
the display unit, configured to display a first interactive object such that the M images as a whole are browsed by the user in a case that the user browses the N images, wherein the first interactive object comprises a first image and a first identifier representing one or more of the M images.

13. The electronic device according to claim 12, wherein the M images with the first correlation attribute are captured via a continuous shoot function of the electronic device within a first period of time.

14. The electronic device according to claim 12, wherein the first correlation attribute is obtained by determining a similarity among the M images to be greater than a threshold in an image analysis algorithm.

15. The electronic device according to claim 12, wherein the M images with the first correlation attribute are stored in one folder.

16. The electronic device according to claim 12, wherein the first identifier is an icon representing that the first interactive object includes a plurality of files.

17. The electronic device according to claim 12, wherein the first image is one of the M images.

18. The electronic device according to claim 12, wherein the first image comprises thumbnails of I images of the M images, wherein I is an integer in a range of 1≦I≦M.

19. The electronic device according to claim 12, wherein the electronic device further comprises a detecting module configured to detect whether a first operation performed on the first interactive object is received,
wherein the display unit is further configured to present the M images in a first mode in a case that the first operation performed on the first interactive object is received.

20. The electronic device according to claim 19, wherein the first mode is to skip to a first folder where the M images are stored.

21. The electronic device according to claim 19, wherein the first mode is further to display thumbnails of the M images on the display unit.

22. The electronic device according to claim 19, wherein the first mode is further to display the M images in sequence via slide.
